(19) United States
(12) Patent Application Publication
(10) Pub. No.: US 2007/0075102 A1
(43) Pub. Date: Apr. 5, 2007

(54) Dispensing device

(76) Inventor: Kenneth Simon Moore, Hampshire (GB)

Correspondence Address: FLYNN THIEL BOUTELL & TANIS, P.C., 2026 RAMBLING ROAD, KALAMAZOO, MI, 49008-1631, US

(21) Appl. No.: 11/509,313

(22) Filed: Aug. 24, 2006

Related U.S. Application Data
(63) Continuation-in-part of application No. PCT/EP05/50834, filed on Feb. 28, 2005.

(30) Foreign Application Priority Data
Feb. 27, 2004 (FR) 0402064

(51) Int. Cl. B67D 3/00; B65D 88/54

(52) U.S. Cl. 222/519; 222/321.7

(57) ABSTRACT

This invention provides a device for dispensing a fluid comprising a bottle for containing a fluid, a dispensing pump fixed to the bottle and comprising a button capable of being actuated to deliver the fluid and a cover arranged to protect the button from actuation, and the cover being capable of being moved relative to the bottle between an OPEN position, in which the cover is retracted in a substantially parallel manner along the bottle and the button is exposed, and a CLOSED position, in which the cover covers the button to prevent actuation thereof, wherein the cover and the bottle include elastically-engaging stop means arranged to stop the movement of the cover at the defined OPEN and CLOSED positions.

### CROSS-REFERENCE TO RELATED APPLICATION

This application is a Continuation-in-Part of International Patent Application PCT/EP2005/050834 with international filing date Feb. 25, 2005, published under the No. W02005/082720.

### BACKGROUND OF THE INVENTION

The present invention concerns a device for dispensing a liquid, or the like such as a cream, or a gel, of the pharmaceutical or cosmetic type, for example, perfume. More particularly, the invention concerns a dispensing device comprising a bottle suitable for containing the liquid with a dispensing pump fixed to one end of the bottle. A button or similar actuator is provided to allow actuation of the dispensing pump, for example by pressure or rotation.

As the pump can be actuated by simple pressing or rotation, this type of device is often actuated by mistake, in particular when it is placed in a voluminous handbag. In order to remedy this drawback, it is known to provide a fixed cover over the button used to actuate the fluid dispensing pump, for example via a threaded or snap-fit connection. However, this cover may sometimes become dislodged and thereby mislaid.

French Patent Specification 2606298 to Jacques describes an atomiser in which the actuation member is translationally moved between an actuation position and a position in which it is retracted, in the atomiser body. French Patent Specification 2777868 to Xavier and U.S. Pat. No. 6,290,103 to Fraillon each describes a perfume bottle with a pump mounted on its neck. However all three of these structures are relatively complex and expensive to make and it is still easy for the actuator to become exposed when not desired. U.S. Pat. No. 2,700,484 to Rathsprecher describes a further arrangement in which an actuator can be locked against depression. This is likewise complex and expensive to make and is not particularly easy to use.

### SUMMARY OF THE INVENTION

The present invention seeks to overcome the above-described problems in a simple and effective manner by providing a two-component dispensing device for dispensing a liquid or the like comprising a bottle for containing a fluid, a dispensing pump fixed to the bottle and comprising a button capable of being actuated to deliver the fluid, the bottle and the dispensing pump constituting a first component, and a cover constituting a second component and arranged to protect the button from actuation, the cover being capable of being moved relative to the bottle between an OPEN position, in which the cover is retracted in a substantially parallel manner along the bottle and the button is exposed, and a CLOSED position, in which the cover covers the button to prevent actuation thereof, wherein the cover and the bottle include radially-directed elastically-engaging stop means arranged to resist movement of the cover at one or preferably both of the defined OPEN and CLOSED positions.

The present invention defines specific OPEN and CLOSED positions as described above and also provides means for positively engaging the cover in these two positions. However, the stop means are “elastically engaging” and therefore, by application of force, the stop may be elastically released to allow the cover to be moved to the other defined position. For example, the elastically-engaging stop means may comprise a releasable snap bead arrangement or an arrangement where a boss or projection engages in a slot or defined recess.

According to particular embodiments of the invention, the device may further have one or more of the following characteristics:
The bottle has at least one cylindrical part and the cover comprises a 25 hollow cylindrical sleeve capable of accommodating said cylindrical part of the bottle.
The cylindrical part of the bottle comprises at least one helical thread and the inner wall of the hollow cylindrical sleeve comprises at least one internal screw thread capable of co-operating with the bottle thread in order to move the sleeve relative to the bottle using a screwing movement.
The dispensing device includes means for retarding the movement of the cover relative to the bottle, the retarding means comprising at least one damping piece, which retards and smoothes the movement of the cover on the bottle, giving the dispensing device a feeling of quality.
The bottle includes a means for gripping the bottle whereby the cover only envelops the cylindrical portion of the bottle, leaving the gripping means exposed to constitute a means for holding the bottle during the movement of the sleeve.
The gripping means comprise a cylindrical seat with diameter greater than that of the body of the bottle.
The dispensing device includes means for holding the cover permanently on the bottle.
The means for holding the cover permanently on the bottle comprise a flange defined on the bottle and an annular rib integral with the inner wall of the cover, the annular rib being suitable for abutment against the flange in order to limit the translational movement the cover.
The cover comprises an orifice for passage of the button and a protective disk is fixed to cover the orifice, the disk being detached at the time of first use of the pump.
The button for the pump is capable of being actuated by pressure along an axis of actuation and the cover is capable of being moved in relation to the bottle with a rotational and translational movement parallel to said axis of actuation.
The gripping means comprise a cylindrical seat with diameter greater than the body of the bottle.

### BRIEF DESCRIPTION OF THE DRAWINGS

The invention will now be described, by way of example only, with reference to the accompanying drawings, in which:

FIG. 1 shows a cross sectional view of a first dispensing device embodying the invention, with the cover in a position protecting the device from accidental actuation;

FIG. 2 shows a cross sectional view of the dispensing device shown in FIG. 1, with the cover in a position allowing actuation;

FIG. 3 is a cross sectional view of the protective cover for the dispensing device shown in FIGS. 1 and 2;

FIG. 4 shows a cross sectional view of a second dispensing device embodying the invention, with the cover in a position protecting the device from accidental actuation;

FIG. 5 shows a cross sectional view of the dispensing device shown in FIG. 4, with the cover in a position allowing actuation;

FIG. 6 is a cross sectional view of the protective cover for the dispensing device shown in FIGS. 4 and 5;

FIG. 7 shows a cross sectional view of a third dispensing device embodying the invention, with the cover in a position protecting the device from accidental actuation;

FIG. 8 shows a cross sectional view of the dispensing device shown in FIG. 7, with the cover in a position allowing actuation;

FIG. 9 is a cross sectional view of the protective cover for the dispensing device shown in FIGS. 7 and 8;

FIG. 10 shows a cross sectional view of a fourth dispensing device embodying the invention, with the cover in a position protecting the device from accidental actuation;

FIG. 11 shows a cross sectional view of the dispensing device shown in FIG. 10, with the cover in a position allowing actuation; and

FIG. 12 is a cross sectional view of the protective cover for the dispensing device shown in FIGS. 10 and 11.

### DETAILED DESCRIPTION OF THE PREFERRED EMBODIMENTS

Four embodiments of the invention are illustrated in the drawings and will now be described.

### First Embodiment

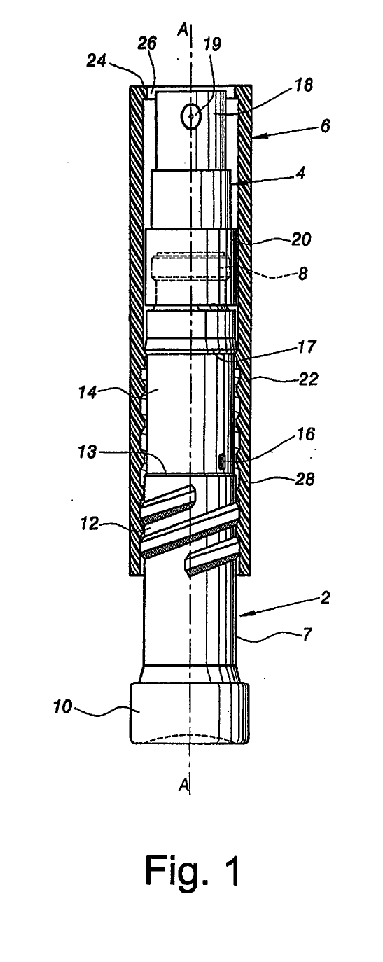

Referring to FIG. 1, a first dispensing device according to the invention comprises a bottle 2, a dispensing pump 4 and a protective cover 6.

The bottle 2 has a cylindrical body 7 and a cylindrical seat 10. The cylindrical body 7 is hollow and suitable for containing a fluid to be dispensed. The bottle 2 is made from a thermoplastics material by extrusion or injection blow moulding and the body 7 is mounted on the seat 10. The latter has a diameter greater than the diameter of the body 7 in order to support the body 7 and to form a means of gripping the bottle 2.

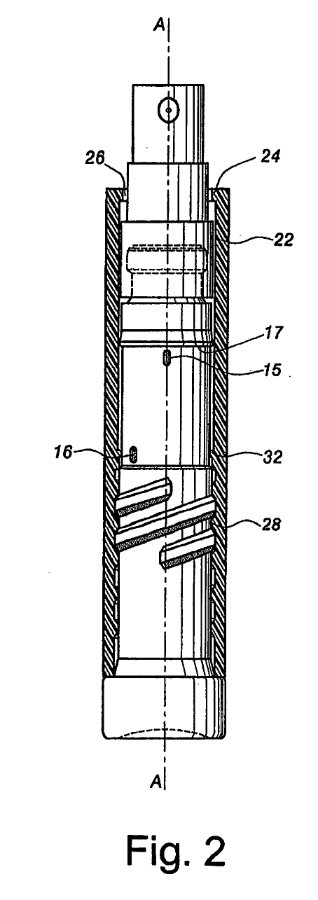

With reference to FIGS. 1 and 2, the external form of the body 7 comprises a threaded section 12 and a shoulder 13 extended by a section of reduced diameter 14. Slots 15, 16 are formed on the section of reduced diameter 14. The section of reduced diameter 14 terminates in a flange 17 and a neck 8 for fixing the pump 4 is accommodated beyond the flange 17. These structures are realized by blow moulding and are designed to co-operate with the cover 6

The pump 4 is of the atomizer or vaporizer type. In particular, it comprises a push button 18, a nozzle 19, a pump system (not shown) and a body 20 screwed or crimped on to the neck 8 of the bottle. The push button 18 is movable relative to the body 7 along the axis A-A in order to actuate the pump 4 to deliver the fluid contained in the bottle 2.

The protective cover 6 is adapted to fit on the body 7. In particular, the cover 6 takes the form of a hollow cylinder 22 comprising at its end a finishing edge 24 and an orifice 26 for passage of the push button 18. The cover 6 is manufactured by injection blow moulding from a thermoplastics material. The material of the cover 6 and the material of the body 7 are chosen to optimise the sliding coefficient and reduce the effort required to screw the bottle 2 relative to the cover 6. For example, the body 7 may be made of polyethylene terephthalate (PETP) and the cover 6 of polypropylene (PP). Alternatively, the body 7 may be made of polypropylene (PP) and the cover 6 in polyethylene (PE).

The inner wall of the hollow cylinder 22 of the cover 6 includes a tapped section 28 followed by a boss 30 and by an annular rib 32 extending radially inwardly in the median part of the sleeve.

The tapped section 28 is adapted to co-operate with the corresponding threaded section 12 on the outer wall of the body 7 of the bottle 2, in order to move the cover 6 in relation to the bottle 2. The threaded section 12 and the tapped section 28 comprise a maximum number of threads corresponding to five turns of the bottle 2.

The cover 6 is adapted to move relative to the bottle 2 between a high position, in which the cover 6 protects the button 18 from accidental activation and a low position, in which the push button 18 protrudes from the orifice 26 and is capable of being actuated.

When the cover 6 is in its high position, it protects the button 18 (as shown in FIG. 1) because the cover 6 extends beyond the button 18 and covers it, preventing any pressure being applied to the button 18. When the cover 6 in this position, it is only possible to press the button 18 along the axis A-A with a finger or object of smaller diameter than that of the orifice 26. Thus, the button 18 is protected when it is carried in a voluminous bag with other objects.

When the cover 6 is in its low position, the button 18 may be actuated (as shown in FIG. 2) because it extends through the orifice 26. The push button 18 is disengaged from the cover over the whole length of its movement, in order to allow transmission of complete finger pressure.

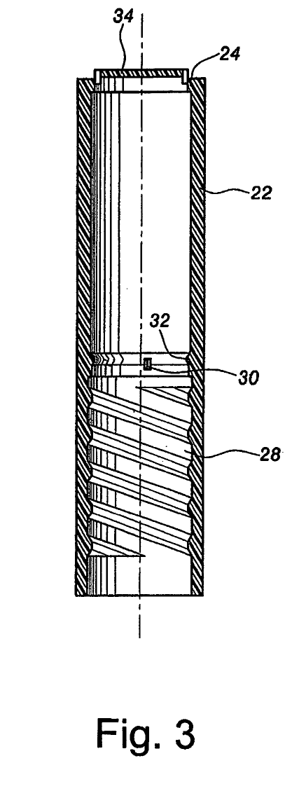

Furthermore, a boss 30 (as shown in FIG. 3) projects radially outwards to the inner wall of the sleeve 6. The boss 30 is adapted to engage in the slots 15 and 16, formed in the section of reduced diameter 14, in order to provide elastic means of electively engaging the cover 6 with the bottle 2. The slot 15 is formed in the upper part of the section of reduced diameter 14, in the vicinity of the flange 17. The angular position of the slot 15 is determined relative to the position of the boss 30, such that the boss 30 co-operates with the slot 15 in a position that corresponds to the position of protection of the button 18.

In a similar manner, the slot 16 is formed in the lower part of the section of reduced diameter 14, in the vicinity of the shoulder 13. The angular position of the slot 16 is defined in the same way as the angular position of the slot 15 so as to stop the cover 6 in a position corresponding to the position of actuation of the button 18.

The section of reduced diameter 14 has a length approximately corresponding to the extent of movement of the cover 6.

The annular rib 32 is formed around the whole of circumference of the internal wall of the cover 6. It has a rounded shape in order to allow it to be forced past the flange 17, when the cover 6 is mounted on the bottle 2.

The annular rib 32 on the cover 6 and the flange 17 on the bottle 2 provide a means of holding the cover 6 permanently on the bottle 2. They prevent separation and uncoupling of the cover 6 from the bottle 2 after one is mounted on the other. Once assembled, the annular rib 32 will abut against the flange 17 if the bottle is rotated beyond the elastic engaging means 15, 30.

As shown in FIG. 3, a protective disk 34 is initially fixed to the finishing edge 24 of the cover 6 by frangible bridges, in order to cover the orifice 26 and prevent passage of the button 18 therethrough. The disk 34 is suitable for being detached on first use of the pump 4. The disk 34 allows the non-use of the bottle 2 to be checked before sale. It gives information relating to the quality of the product sold in the distribution system. The disk 34 is also made of a plastics material and is integrally moulded with the cover 6. Alternatively, a simple self-adhesive label may be used instead of the disk 34.

During use of the dispensing device according to the invention, a user holds the seat 10 of the bottle 2 in one hand, while the other hand rotates the cover 6. The cover 6 is thereby driven relative to the bottle 2 by a rotational movement about axis A-A combined with a translational movement parallel to the axis A-A. The seat 10 advantageously forms a means of gripping the bottle 2.

When the cover 6 is moved from the position of protection of the push button 18 to the position allowing actuation of the button 18, the boss 30 snaps into the slot 16 to stop the movement of the cover 6 in the position allowing actuation of the button 18. Similarly, during movement of the sleeve from the position allowing actuation of the push button 18 to the position of protection of the button 18, the boss 30 snaps into the slot 15 to stop the movement of the cover 6 in the position where it protects the button 18.

The cover 6 may, for example, be decorated by silkscreen printing, by hot marking or any other transfer process used in the decoration of hollow bodies. It can likewise be varnished, lacquered or covered with an external coating.

The bottle 2 may take a round, square or other shape, provided it comprises a cylindrical part on which the protective cover 6 may be mounted.

The push button 18 may be replaced with a lever adapted to be actuated by rotation around its main axis. In this case, this lever is likewise protected by a cover 6, which extends around the lever and prevents undesirable rotation of the latter.

The protective cover 6 may be provided by two tongues fixed to a tapped ring, the tongues having a length sufficient to extend beyond the push button 18 along the axis A-A, so as to protect it from any pressure, particularly pressure along an axis parallel to the axis of actuation A-A of the push button 18.

The slots 15 and 16 may be enhanced by the provision of damping buffers. Such buffers terminate in pieces projecting radially in relation to the outer wall of the bottle 2. The buffers rub against the boss 30 to dampen the movement of the cover 6 in the positions of actuation and protection of the push button 18. The damping buffers and the boss provide means for retarding the movement of the cover 6 relative to the bottle 2. Alternatively, these pieces take the form of a double cover 6 between which the boss 30 is adapted to engage.

Advantageously, the length of the cover 6 approximately corresponds to the length of the bottle 2 so that when the dispensing device is in a position allowing the actuation of the pump 4, the sleeve 6 envelops the body 7 of the bottle 2 and thus constitutes a means for protection against shocks.

Preferably, the diameter of the cover 6 corresponds to the diameter of the seat 10 to provide a continuous finish, which presents improved aesthetic effect.

Alternatively, in a non-illustrated embodiment, the inner wall of the cover 6 may comprise two bosses 30 and the outer wall of the body 7 of the bottle 2 comprises a single slot 15 adapted to engage into each of the bosses to define the position of actuation of the push button 18 and the position of protection of the push button 18 respectively.

### Second Embodiment

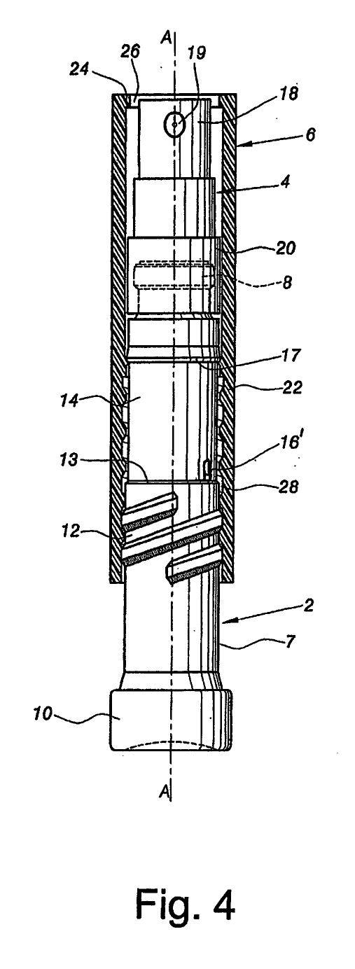

A second illustrated embodiment of the invention is shown in FIG. 4 to 6 of the drawings. In the second embodiment the slots 15, 16 of the first embodiment and the boss 30 are to some extent interchanged, that is the slots 15, 16 are replaced by short longitudinal beads 15′, 16′ on the bottle, and the boss 30 is replaced by other features on the interior wall of the cover. In particular the boss 30 is replaced by two detents on the interior wall of the cover, a first of which is a notch 36 in the rib 32 and which engages the bead 15′ in the CLOSED position of the cover, and the second of which is a short longitudinal bead 38 on the inner wall of the cover which passes over and engages beyond the short longitudinal bead 16′ in the OPEN position of the cover. All these elastically-engaging elements extend in the radially inward or outward direction. They provide a snapping action at the two end positions of the cover on the bottle.

More particularly, and referring first to FIG. 4, the second illustrated dispensing device embodying the invention comprises a bottle 2, a dispensing pump 4 fixed to the bottle, and a protective cover 6.

The bottle 2 again has a generally cylindrical body 7 and a cylindrical seat 10 forming a manually-grippable portion of the bottle. The cylindrical body 7 has an elongate axis A-A and is hollow and suitable for containing a liquid or the like to be dispensed. The bottle 2 has an open upper end as seen in FIGS. 4 to 6 and a lower closed end formed by the seat 10, and is made from a thermoplastics material by extrusion or injection blow moulding. The seat 10 has a diameter greater than the diameter of the body 7 in order to support the body 7 and to form a means for gripping or holding the bottle 2.

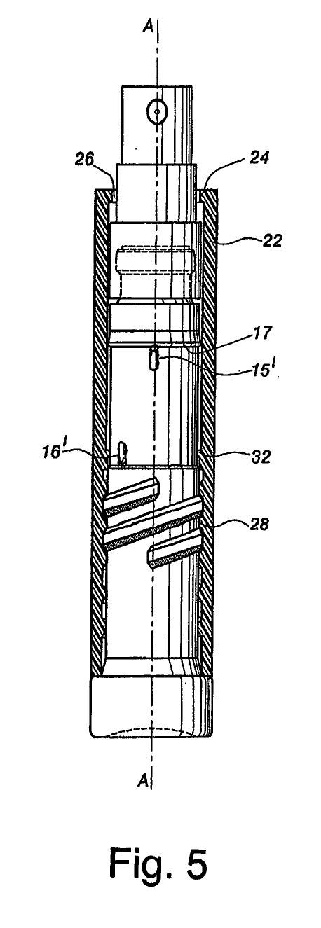

With reference to FIGS. 4 and 5, the external form of the body 7 comprises a threaded section 12 and a shoulder 13 extended by a section of reduced diameter 14. Two short longitudinal beads or ridges 15′, 16′ are formed on the section of reduced diameter 14, the beads being radially-extending outwardly relative to the axis A-A. The section of reduced diameter 14 terminates in a flange 17, and a neck 8 for fixing the pump 4 is accommodated beyond the flange 17. These structures are realized by blow moulding and are designed to co-operate with the cover 6.

The pump 4 again is of the atomizer or vaporizer type. In particular, it comprises an actuator in the form of a push button 18, a nozzle 19, a pump system (not shown), and a body 20 screwed or crimped on to the neck 8 of the bottle. The push button 18 is movable relative to the body 7 along the axis A-A in order to actuate the pump 4 to deliver the liquid contained in the bottle 2.

The protective cover 6 is adapted to fit on the body 7 and over the push button. In particular, the cover 6 takes the form of a hollow cylinder 22 comprising at its upper end as seen a finishing edge 24 and an orifice 26 for passage of the push button 18. The cover 6 is manufactured by injection blow moulding from a thermoplastics material. The material of the cover 6 and the material of the body 7 are chosen to optimise the sliding coefficient and reduce the effort required to screw the bottle 2 relative to the cover 6. For example, the body 7 may be made of polyethylene terephthalate (PETP or PET) and the cover 6 of polypropylene (PP). Alternatively, the body 7 may be made of polypropylene (PP) and the cover 6 in polyethylene (PE).

The inner wall of the hollow cylinder 22 of the cover 6 includes a tapped or inwardly-threaded section 28 followed by an annular rib 32 extending radially inwardly in the median part of the sleeve with a notch 36 at one position in the rib 32. Just below the rib 32 an inwardly-extending short longitudinal bead 38 is formed on the inner wall of the cover 6.

The tapped or inwardly-threaded section 28 is adapted to co-operate with the corresponding threaded section 12 on the outer wall of the body 7 of the bottle 2, in order to allow axial and rotational movement of the cover 6 relative to the bottle 2. Preferably the threaded section 12 and the tapped section 28 comprise a maximum number of threads corresponding to five turns of the bottle 2.

The cover 6 is adapted to move relative to the bottle 2 between a high or CLOSED position, in which the cover 6 shields and protects the button 18 from accidental activation, and a low or OPEN position, in which the push button 18 protrudes from the orifice 26 and is exposed and capable of being actuated.

When the cover 6 is in its high position, it protects the button 18 (as shown in FIG. 4) because the cover 6 extends beyond the button 18 and covers it, preventing any pressure being applied to the button 18. When the cover 6 in this position, it is only possible to press the button 18 along the axis A-A with a finger or object of smaller diameter than that of the orifice 26. Thus, the button 18 is protected when it is carried in a voluminous bag with other objects.

When the cover 6 is in its low position, the button 18 may be actuated (as 25 shown in FIG. 5) because it extends through the orifice 26. The arrangement is such that the push button 18 is disengaged from the cover over the whole length of its movement, in order to allow transmission of complete finger pressure.

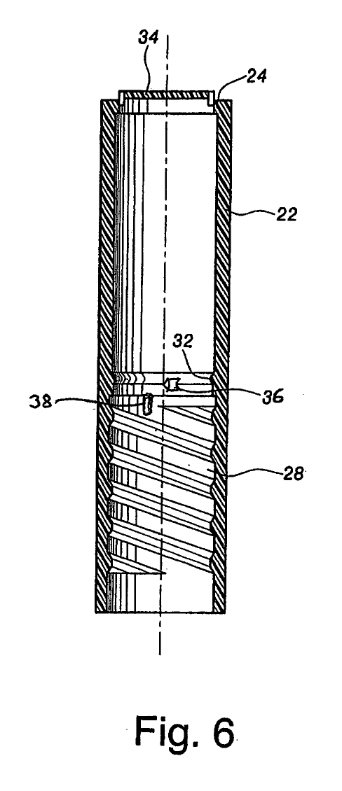

Furthermore, the notch 36 (as shown in FIG. 6) is formed radially in the inner wall of the sleeve 6. The notch 36 is adapted to engage in the bead 15′, formed in the section of reduced diameter 14, in order to provide elastic means for electively engaging the cover 6 with the bottle 2. The bead 15′ is formed in the upper part of the section of reduced diameter 14, in the vicinity of the flange 17. The angular position of the bead 15′ is determined relative to the position of the notch 36, such that the notch 36 co-operates with the bead 15′ in a position that corresponds to the position of protection of the button 18, i.e. the CLOSED position.

In a similar manner, the bead 16′ is formed in the lower part of the section of reduced diameter 14, in the vicinity of the shoulder 13, so as to pass over and engage behind the bead 38 on the inner wall of the cover. The angular position of the bead 16′ is defined relative to the bead 38 in a similar way as the angular position of the bead 15′ so as to resist movement of the cover 6 in a position corresponding to the position of actuation of the button 18, i.e. the OPEN position.

The section of reduced diameter 14 has a length approximately corresponding to the extent of movement of the cover 6.

The annular rib 32 may be formed around the whole of circumference of the internal wall of the cover 6. It has a rounded shape in order to allow it to be forced past the flange 17, when the cover 6 is mounted on the bottle 2. There may however be a gap (not shown) in the circumferential extent of the rib 32. The gap is located close to the notch 36 and extends up to about one-quarter of the way round the cover.

The annular rib 32 on the cover 6 and the flange 17 on the bottle 2 provide a means for holding the cover 6 permanently on the bottle 2. They prevent separation and uncoupling of the cover 6 from the bottle 2 after one is mounted on the other. Once assembled, the annular rib 32 will abut against the flange 17 if the bottle is rotated beyond the elastic engaging means 15′, 36.

As shown in FIG. 6, a protective disk 34 is initially fixed to the finishing edge 24 of the cover 6 by frangible bridges, in order to cover the orifice 26 and prevent passage of the button 18 therethrough. The disk 34 is suitable for being detached on first use of the pump 4. The disk 34 allows the non-use of the bottle 2 to be checked before sale. It gives information relating to the quality of the product sold in the distribution system. The disk 34 is also made of a plastics material and is integrally moulded with the cover 6. Alternatively, a simple self-adhesive label may be used instead of the disk 34.

During use of the dispensing device according to the invention, a user holds the seat 10 of the bottle 2 in one hand, while the other hand rotates the cover 6. The cover 6 is thereby driven relative to the bottle 2 by a rotational movement about axis A-A combined with a translational movement parallel to the axis A-A. The seat 10 advantageously forms a means for gripping the bottle 2.

When the cover 6 is moved from the CLOSED position of protection of the push button 18 to the OPEN position allowing actuation of the button 18, the bead 38 pushes across the bead 16′ to retain the cover 6 in the OPEN position against reverse movement allowing actuation of the button 18. Similarly, during movement of the sleeve from the OPEN position allowing actuation of the push button 18 to the CLOSED position of protection of the button 18, the bead 15′ snaps into the notch 36 to retain the cover 6 in the CLOSED position where it protects the button 18 against reverse movement. The gap, if present, in the rib 32 ensures that there is no significant resistance to turning until the CLOSED position is almost reached.

It may be convenient to duplicate the elastically-engaging portions at 180 degree displaced positions around the axis A-A. The gap in the rib 32, if present, is also duplicated. The screw threads on either the bottle or on the inner wall of the cover do not need to be continuous around the device and one of them, conveniently the cover, can have screw threads over only two opposed quadrants with the other two opposed quadrants being smooth and conforming to the surface of the inner wall of the cover.

Other features described above in relation to the first embodiment may also be used in conjunction with the second embodiment.

### Third Embodiment

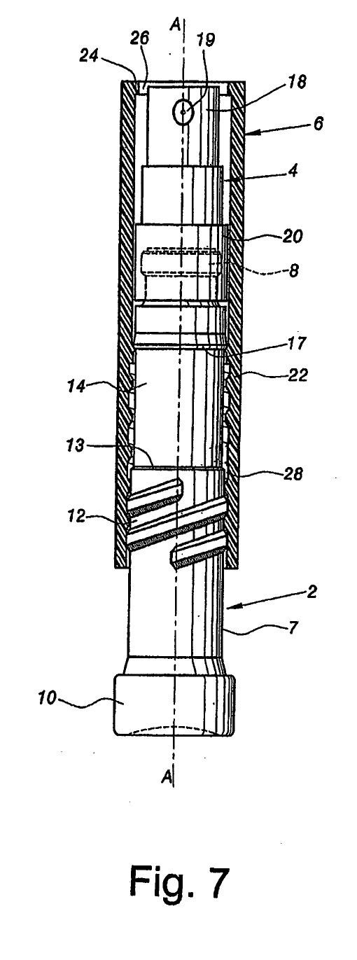

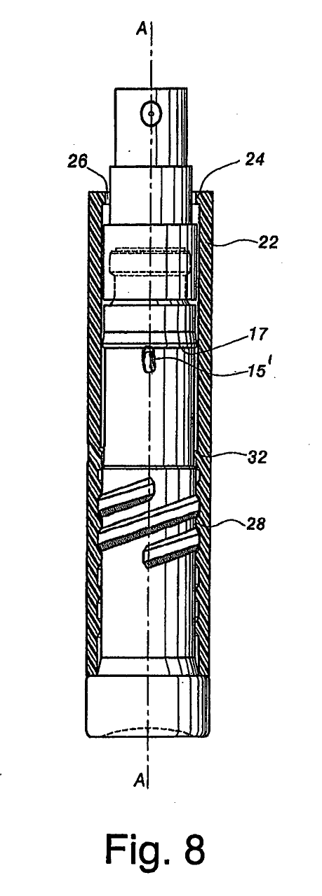

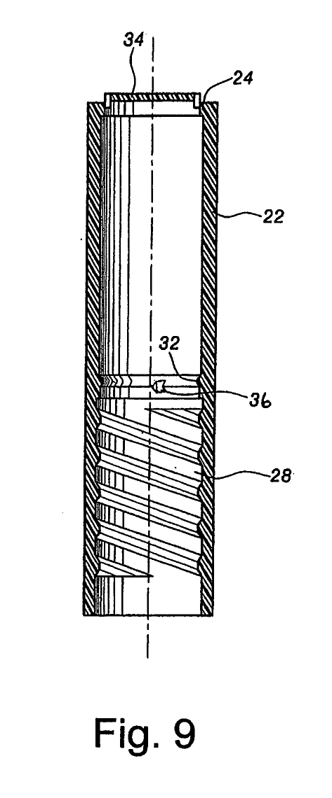

A third illustrated embodiment of the invention is shown in FIGS. 7 to 9 in which a detent arrangement as in the second embodiment is provided only in the closed position of the dispenser. That is, the bead 15′ and the notch 36 are present, but not the bead 16′ and the bead 38. This provides resistance to inadvertent actuation in the user's handbag or the like. Detailed description of this embodiment is not necessary in view of the foregoing description.

### Fourth Embodiment

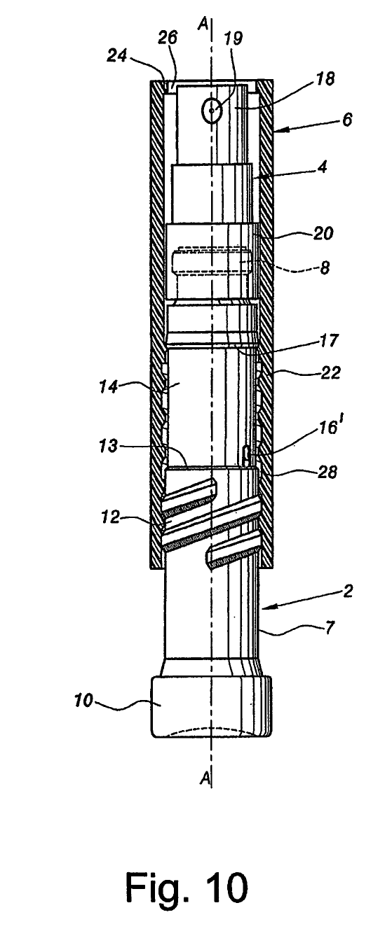

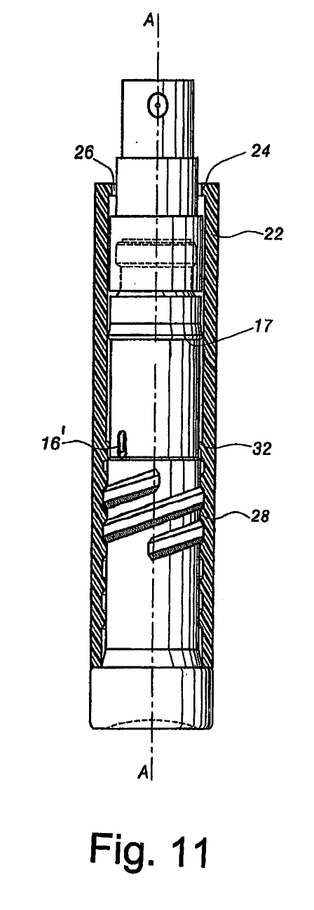

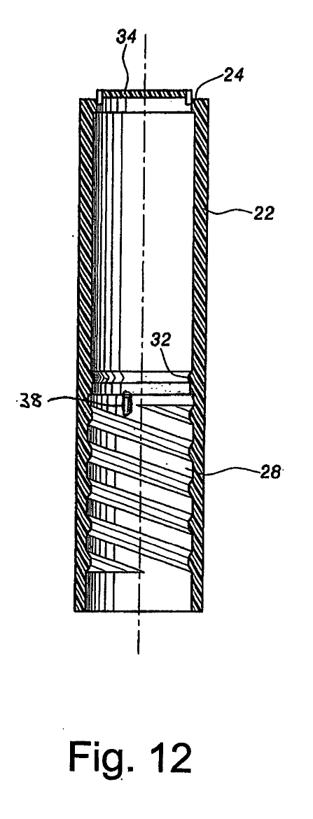

A fourth illustrated embodiment of the invention is shown in FIGS. 10 to 12 in which a detent arrangement as in the second embodiment is provided only in the open position of the dispenser. That is, the bead 16′ and bead 38 are present, but not the bead 15′ and notch 36. This does not provide resistance to inadvertent actuation in the user's handbag or the like, but does ensure that the actuator is retained in the open position when in use and does nor inconveniently collapse as it is being used by the user. As with the preceding embodiment, detailed description of this embodiment is not necessary in view of the foregoing description.

Advantages

The two-component dispenser devices described have the advantage of being relatively simple to manufacture while providing enhanced functionality. In particular they are easy for the user to use, while retaining in the CLOSED and/or OPEN position when the user so desires. They enable the ready dispensing of many consumer products of which perfumes and certain foodstuffs and the like are examples.

Many modifications can be made to the invention other than as shown in the embodiments illustrated in the drawings and the scope of the invention is not to be limited to the features and embodiments specifically set forth but should be determined in accordance with the following claims.

1. A dispensing device comprising:
a first component comprising:
a generally-cylindrical bottle having an elongate axis, and having an open end and a closed end and a manually-grippable portion at said closed end; and
a dispensing pump fixed to said open end of said bottle for movement with said bottle and having an actuator that can be actuated to dispense liquid or the like in said bottle; and
a second component comprising:
a generally-cylindrical cover located around said actuator and around said bottle other than said manually-grippable portion of said bottle, said cover being axially and rotationally moveable relative to said first component by a screw thread internally of said cover engaging a screw thread externally of said first component, said cover being moveable relative to said first component between two end positions namely a CLOSED position where said actuator is shielded by said cover preventing actuation thereof and an OPEN position where said actuator is exposed for actuation by a user;
wherein:
said first and second components include radially-extending elastically-engaging portions arranged to resist movement of said cover relative to said first component at at least one of said end positions.

2. A dispensing device according to claim 1, further comprising braking means adapted to retard the movement of said cover relative to said bottle, said braking means comprising at least one damping piece on one of a cylindrical part of said bottle and an inner wall of said cover, and a cooperating boss on the other of said cylindrical part of said bottle and said inner wall of said cover.

3. A dispensing device according to claim 1, further including means for permanently retaining said cover on said bottle.

4. A dispensing device according to claim 3, wherein said cover is permanently retained on said bottle by a flange provided on said bottle and an annular rib provided on an inner wall of said cover, said flange being arranged to abut an annular rib in order to limit said translation of movement of said cover.

5. A dispensing device according to claim 1, wherein said cover includes an orifice at one end for passage of said button of said dispensing pump, and a protective disk is arranged to cover said orifice, said disk being arranged to break on first use of said pump.

6. A dispensing device according to claim 6, wherein said manually-grippable portion of said bottle comprises a cylindrical seat of greater diameter than the rest of said bottle.

7. A dispensing device according to claim 1, wherein said elastically-engaging portions are arranged to resist movement of said cover relative to said first component in said CLOSED position.

8. A dispensing device according to claim 1, wherein said elastically-engaging portions are arranged to resist movement of said cover relative to said first component in both said CLOSED position and said OPEN position.

9. A dispensing device comprising;
a bottle suitable for holding fluid;
a dispensing pump fixed to said bottle and having a button which can be actuated to dispense fluid; and
a cover movable relative to said bottle between a first position in which said cover is retracted and said button is exposed for actuation and a second position in which said cover covers said button preventing actuation thereof;
wherein said cover and bottle include elastically engaging stop means arranged to stop movement of said cover relative to said bottle at said first and second positions.

10. A dispensing device according to claim 9, further comprising braking means adapted to retard movement of said cover relative to said bottle, said braking means comprising at least one damping piece on either said cylindrical part of said bottle or said inner wall of said cover and a cooperating boss on said other of said cylindrical part of said bottle or said inner wall of said cover.

11. A dispensing device according to claim 9, further including means for permanently retaining said cover on said bottle.

12. A dispensing device according to claim 11, wherein said means for permanently retaining said cover on said bottle comprises a flange provided on said bottle and an annular rib provided on said inner wall of said cover, said flange being
arranged to abut said annular rib in order to limit translational movement of said cover.

13. A dispensing device according to claim 9, wherein said cover includes an orifice at one end for passage of said button of said pump, and a protective disk is arranged to cover said orifice, said disk being arranged to break on first use of said pump.

14. A dispensing device according to claim 9, wherein said bottle comprises a body of cylindrical shape and a gripping portion, said cover only enveloping said cylindrical body leaving said gripping portion exposed to provide a means of holding said bottle during movement of said cover relative to said bottle.

15. A dispensing device according to claim 14, wherein said gripping portion comprises a cylindrical seat of greater diameter than said bottle.

16. A dispensing device consisting of:
a first component comprising:
a generally-cylindrical bottle having an elongate axis, and having an open end and a closed end and a manually-grippable portion at said closed end; and
a dispensing pump fixed to said open end of said bottle for movement with said bottle and having an actuator that can be actuated to dispense liquid or the like in said bottle; and
a second component comprising:
a generally-cylindrical cover located around said actuator and around said bottle other than said manually-grippable portion of said bottle, said cover being axially and rotationally moveable relative to said first component by a screw thread internally of said cover engaging a screw thread externally of said first component, said cover being moveable relative to said first component between two end positions namely a CLOSED position where said actuator is shielded by said cover preventing actuation thereof and an OPEN position where said actuator is exposed for actuation by a user;
wherein:
said first and second components include elastically-engaging portions arranged to resist movement of said cover relative to said first component at said CLOSED position.

17. A dispensing device according to claim 16, wherein said elastically-engaging portions for resisting movement of said cover relative to said first component at said CLOSED position comprise a bead engageable with a notch.

18. A dispensing device according to claim 16, wherein said elastically-engaging portions are arranged to resist movement of said cover relative to said first component in both said CLOSED position and said OPEN position.

19. A dispensing device according to claim 18, wherein said elastically-engaging portions for resisting movement of said cover relative to said first component at said OPEN position comprise two mutually-engageable beads.
